(19) United States
(12) Patent Application Publication
(10) Pub. No.: US 2022/0340118 A1
(43) Pub. Date: Oct. 27, 2022

(54) BRAKING SYSTEM FOR A VEHICLE

(71) Applicant: ZF Active Safety GmbH, Koblenz (DE)

(72) Inventors: Manfred Meyer, Koblenz (DE); Nicholas Alford, Waldesch (DE); Roman Bechmann, Koblenz (DE); Andreas Marx, Hartenfels (DE)

(21) Appl. No.: 17/726,737

(22) Filed: Apr. 22, 2022

(30) Foreign Application Priority Data
Apr. 23, 2021 (DE) 102021110472.6

(51) Int. Cl. B60T 13/74; B60T 8/17; B60T 7/04

(52) U.S. Cl. CPC B60T 13/746; B60T 8/17; B60T 7/042; B60T 2270/402; B60T 2270/82; B60T 2270/404; B62D 6/00

(57) ABSTRACT

The disclosure relates to a braking system for a vehicle having at least four brakable wheels. The braking system comprises at least four brake actuator units, each of which can be associated with one of the wheels of the vehicle, as well as a first electronic control unit and a second electronic control unit. Each brake actuator unit has its own signal line via which the relevant brake actuator unit is connected in terms of signaling to the first control unit and the second control unit, so that each of the brake actuator units can be actuated both by the first control unit and by the second control unit.

### CROSS-REFERENCE TO RELATED APPLICATION

This application claims priority to German Priority Application No. 102021110472.6, filed Apr. 23, 2021, the disclosure of which is incorporated herein by reference in its entirety.

### TECHNICAL FIELD

The disclosure relates to a braking system for a vehicle having at least four breakable wheels. The braking system comprises at least four brake actuator units, each of which can be associated with one of the wheels of the vehicle, and a first electronic control unit.

### BACKGROUND

Such braking systems are known from the prior art.

A first control unit can be designed to implement what is known as a brake-by-wire operation. In such an operation, a brake pedal is used to simply take a braking request from a driver of the vehicle. On the basis of this braking request, individual brake actuator units are then activated by the first electronic control unit. There is no mechanical connection between the brake pedal and the brake actuator units.

Furthermore, known first control units can be designed to activate the brake actuator units in an automated manner, i.e. without the brake pedal being actuated for this purpose. Driver assistance systems, for example adaptive cruise control or an emergency brake assistant, can thus be implemented by such first control units. In this context, this can also be referred to as partially autonomous and autonomous operation of the vehicle.

Since a braking system is a safety-relevant device of a vehicle, usually at least certain components or functions are designed redundantly within a braking system so that the braking system can work reliably even if a malfunction or a defect occurs. In other words, redundancies are provided within a braking system in order to achieve a high level of operational reliability.

### SUMMARY

Against this background, a problem sought to be addressed by exemplary arrangements of the disclosure are further improving known braking systems. In particular, in one exemplary arrangement, a braking system is to be provided which has a high level of operational reliability even in the case of an autonomous or partially autonomous operation of an associated vehicle.

More specifically, a braking system of the type mentioned at the outset which comprises a second electronic control unit is proposed. Furthermore, each brake actuator unit has its own signal line via which a relevant brake actuator unit is connected in terms of signaling to the first control unit and the second control unit, so that each of the brake actuator units can be actuated both by the first control unit and by the second control unit. The braking system is thus designed to be redundant with regard to the electronic control units. This means that even if one of the electronic control units fails, all of the brake actuator units can be operated reliably. Thus, even in such a case, a full braking power can be provided. This applies regardless of whether the braking system is actuated by actuation of a brake pedal or in an automated manner, i.e. in an autonomous or partially autonomous driving mode. Such a braking system is also referred to as “fail operational” because it is substantially fully functional even in the event of a fault.

There are basically two alternatives to the redundant design of the two electronic control units. In a first alternative, only one of the electronic control units is used in normal operation, i.e. in an operating situation in which there is no defect or malfunction. The other electronic control unit is therefore not involved in the normal operation and only becomes operational if a defect or a malfunction occurs in the other electronic control unit. In a second alternative, in normal operation, certain functions of the braking system are realized by the first electronic control unit and other functions are realized by the second electronic control unit, with each of the two control units being capable of executing all functions, of course. Both control units are therefore used even in normal operation. Depending on which of the control units is defective or malfunctioning, the associated functions are then taken over by the other control unit in question.

If a brake actuator unit fads in a braking system according to the disclosure, it is obviously no longer available to provide a braking effect. Overall, however, the remaining at least three brake actuator units can usually provide approximately 70% of the braking power that is available in fault-free operation.

In one exemplary arrangement, the braking system comprises a first power supply unit and a second power supply unit, the power supply units being independent of one another. The braking system is therefore also designed to be redundant with regard to the power supply. This arrangement leads to a particularly high level of operational reliability, since the braking system is still ready for use in the case of a defect in one of the power supply units.

A first subset of the brake actuator units can be coupled to the first power supply unit for the supply of power and a second subset of the brake actuator units can be coupled to the second power supply unit for the supply of power. In one exemplary arrangement, the first subset and the second subset are free of intersections. Thus, even if one of the power supply units fails, at least a subset of the brake actuator units is available for braking.

Alternatively, in one exemplary arrangement, each of the brake actuator units can optionally be coupled to the first power supply unit and to the second power supply unit for the supply of power. Each brake actuator unit can therefore be supplied with power by the first power supply unit or by the second power supply unit. If one of the two power supply units fails, all the brake actuator units can still be supplied with power. Such a braking system can consequently be operated with high reliability.

It is also possible that the first control unit and/or the second control unit can optionally be coupled to the first power supply unit and to the second power supply unit for the supply of power. Consequently, in one exemplary arrangement, the first control unit and/or the second control unit can optionally be supplied with power by the first power supply unit or by the second power supply unit. If one of the two power supply units fans, the control units can still be supplied with power. The braking system thus operates particularly reliably.

According to one exemplary arrangement, the first control unit is coupled to a first power supply switch for the supply of power, the first power supply switch connecting the first control unit to the first power supply unit in a first switching position and connecting the first control unit to the second power supply unit in a second switching position. Alternatively or additionally, the second control unit is coupled to a second power supply switch for the supply of power, the second power supply switch connecting the second control unit to the first power supply unit in a first switching position and connecting the second control unit to the second power supply unit in a second switching position. Alternatively or additionally, each of the brake actuator units is coupled to a first power supply switch or a second power supply switch for the supply of power, the first power switch connecting the relevant brake actuator unit to the first power supply unit in a first switching position and connecting the relevant brake actuator unit to the second power supply unit in a second switching position, and the second power supply switch connecting the relevant brake actuator unit to the first power supply unit in a first switching position and connecting the relevant brake actuator unit to the second power supply unit in a second switching position. Ideally, the first control unit, the second control unit and all the brake actuator units can optionally be supplied with power by one of the two power supply units. The power supply switches make it possible for both control units as well as all the brake actuator units to be supplied with power even in cases where one of the power supply units has failed. Even in the event of a defect in one of the power supply units, the full performance range of the braking system is still available. In particular, the redundancy of the control units is maintained even if one of the power supply units fails.

Each of the brake actuator units advantageously comprises an electromechanical brake actuator. Such brake actuator units are often referred to as an EMB (electromechanical brake). The EMBs generally comprise an electric motor that is coupled to a spindle drive. In this way, brake pads can be applied to an associated brake disk by operation of the spindle drive in order to brake an associated wheel. Due to the fact that electromechanical brake actuators do not use hydraulic fluid, they are often also referred to as dry brake actuators. Such brake actuators are particularly well suited for use in a brake-by-wire system or in a brake-by-wire operation. Such actuators have a long service life and can be easily installed on an associated vehicle, since they essentially only have to be connected to a power supply and a control unit.

Furthermore, a brake actuation unit can be provided which is coupled in terms of signaling both to the first control unit and to the second control unit, in particular with the brake actuation unit comprising a brake pedal. Such a brake actuation unit is used to detect a driver's request. The actuation unit could therefore also be referred to as a driver's request detection unit. In one exemplary arrangement, the brake actuation unit comprises sensors for detecting the driver's request, for example a pedal force sensor or a pedal position sensor. The brake actuation unit can also comprise a so-called pedal simulator, which is an assembly that is designed to generate a restoring force on the brake pedal. These aforementioned sensors are coupled in terms of signaling both to the first control unit and to the second control unit. A driver's request can thus be reliably detected.

In one exemplary arrangement, the actuation unit is coupled to the two control units via separate signal lines in each case.

In a variant, the first control unit and the second control unit are coupled to the signal lines of the brake actuator units via at least one gateway. A gateway refers to a hardware and/or software component that establishes a connection between two systems. This implies that the forwarded data are processed. This means that the necessary control signals can be provided to the brake actuator units in a desired form with a high degree of reliability.

In one exemplary arrangement, t]he braking system comprises at least two gateways. This means that the braking system is also designed to be redundant with regard to the gateways. A first gateway can be coupled to a first subset of the brake actuator units and a second gateway can be coupled to a second subset of the brake actuator units. In particular, the two subsets are free of intersections.

If at least two gateways are provided, one of the gateways can be arranged in the region of the first electronic control unit and the second gateway can be arranged in the region of the second electronic control unit.

In one exemplary arrangement, one of the gateways is arranged so as to be adjacent to or integrated into the first electronic control unit. The same applies to the second gateway.

The first control unit and the second control unit can be arranged so as to be adjacent to or at a distance from one another. The braking system can thus be mounted relatively flexibly in an existing installation space of an associated vehicle. Regardless of the positioning of the control units, their functional independence is of course maintained.

In one exemplary arrangement, one of the signal lines is a bus line. In this way, the braking system can be designed in a structurally simple manner. In particular, the cost of cabling is kept low.

According to a design alternative, the first control unit and/or the second control unit can be or is coupled in terms of signaling to a steering actuator unit, so that the steering actuator unit can be actuated by the first control unit and/or by the second control unit. The first control unit and/or the second control unit are thus used both to actuate the brake actuator units and to actuate a steering actuator unit. The first control unit and/or the second control unit is therefore a combined control unit for a braking system and a steering system. In particular, if a conventional braking system and a conventional steering system are considered together, at least one control unit can be dispensed with as a result of such a structure. All in all, this results in a comparatively simple and thus cost-effective structure.

If the first control unit and/or the second control unit can be or is coupled in terms of signaling to a steering actuator unit, the braking system according to the disclosure is of course also a steering system at the same time. The disclosure is thus equally directed to a steering system.

In addition, such a system can be referred to as a combined steering and braking system. More generally speaking, it can also be referred to as a direction control system or DOC system (digital direction control).

If the steering actuator unit is coupled to both control units, there is also redundancy with regard to the actuation of the steering actuator unit.

In the present case, a steering actuator unit is understood to mean any actuator unit of a steering system.

The steering actuator unit can be a steering drive unit that can be associated with a front axle or a feedback unit that can be associated with a steering wheel. A steering drive unit that can be associated with a front axle is also referred to as an FAA (front axle actuator) and a feedback unit that can be associated with a steering wheel is also referred to as an HWA (hand wheel actuator). When the braking and steering systems are considered together, at least one control unit can thus be omitted again.

In addition, it is possible for a steering actuation unit to be coupled in terms of signaling to both the first control unit and the second control unit. In particular, the steering actuation unit comprises a steering wheel. The steering actuation unit is thus redundantly coupled to the control units. This is particularly advantageous when it is a matter of steer-by-wire steering, that is to say when there is no mechanical connection between the steering wheel, i.e. steering actuation unit, and the wheels to be steered. The coupling of the steering actuation unit is also highly reliable.

At least one driving state sensor can also be coupled in terms of signaling to both the first control unit and the second control unit. The braking system can thus be operated on the basis of driving states detected by sensors. In particular, the driving state sensors also comprise sensors that detect the surroundings of the vehicle. The braking system can thus be used in a partially autonomous or autonomous operation of the vehicle.

### BRIEF DESCRIPTION OF DRAWINGS

The disclosure is explained below with reference to various exemplary arrangements which are shown in the accompanying drawings, in which:

FIG. 1 shows a braking system according to the disclosure in a schematic circuit diagram,

FIG. 2 is a simplified view of a variant of the braking system from FIG. 1 and

FIG. 3 shows a further variant of the braking system according to the disclosure, which is specially designed for use in autonomously or partially autonomously operated vehicles.

### DETAILED DESCRIPTION

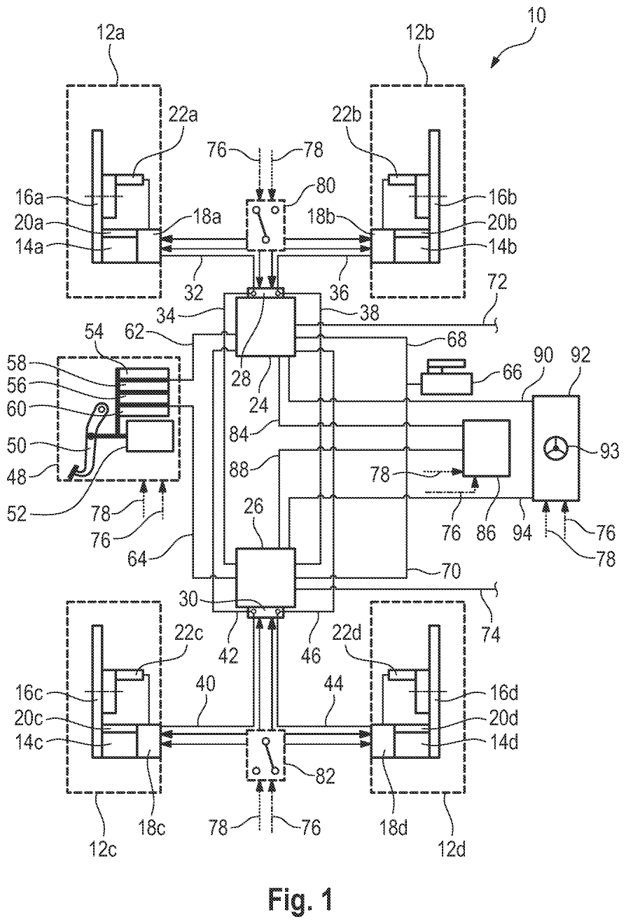

FIG. 1 shows a braking system 10 for a vehicle having a total of four brakable wheels.

The braking system 10 therefore comprises a total of four brake actuator units 12a, 12b, 12c, 12d, each of which is associated with one of the wheels of the vehicle (not shown in detail).

The brake actuator unit 12a is associated with a front-left wheel. The brake actuator unit 12b is associated with a front-right wheel. The brake actuator unit 12c is associated with a rear-left wheel and the brake actuator unit 12d is associated with a rear-right wheel.

In one exemplary arrangement, the brake actuator units 12a, 12b, 12c, 12d are constructed identically.

Each of the brake actuator units 12a, 12b, 12c, 12d comprises an electromechanical brake actuator 14a, 14b, 14c, 14d, which comprises an electric motor (not shown in detail) having a spindle drive.

By actuating the electric motor, a brake pad coupled to the spindle drive can thus be applied to an associated brake disk 16a, 16b, 16c, 16d, thus producing a braking effect.

Furthermore, each of the brake actuator units 12a, 12b, 12c, 12d is equipped with its own controller 18a, 18b, 18c, 18d, which is used to control the respectively associated electromechanical brake actuator 14a, 14b, 14c, 14d.

In addition, each of the brake actuator units 12a, 12b, 12c, 12d has a position sensor 20a, 20b, 20c, 20d by which, for example, a position of the electromechanical brake actuator 14a, 14b, 14c, 14d can be detected.

Furthermore, a rotational speed sensor 22a, 22b, 22c, 22d is provided in each of the brake actuator units 12a, 12b, 12c, 12d, by which a rotational speed of the wheel associated with the relevant brake actuator unit 12a, 12b, 12c, 12d can be detected.

The position sensors 20a, 20b, 20c, 20d and the rotational speed sensors 22a, 22b, 22c, 22d are each connected in terms of signaling to their associated controllers 18a, 18b, 18c, 18d.

The braking system 10 also has a first electronic control unit 24 and a second electronic control unit 26.

In the exemplary arrangement shown, the first electronic control unit 24 and the second electronic control unit 26 are positioned at a certain distance from one another on the vehicle. More precisely, the control unit 24 is arranged in a front region of the vehicle and the control unit 26 is arranged in a rear region, but this is not intended to be limiting.

Furthermore, a first gateway 28 is provided adjacent to the first control unit 24 and a second gateway 30 is provided adjacent to the second control unit 26.

The controller 18a is coupled to the first gateway 28 via a signal line 32. The first gateway 28 is in turn connected in terms of signaling to the first control unit 24. In addition, a signal line 34 extends from the first gateway 28 to the second control unit 26.

The controller 18a and thus the brake actuator unit 12a are thus connected in terms of signaling via separate signal lines 32, 34 to both the first control unit 24 and the second control unit 26.

The brake actuator unit 12a can therefore be actuated by the first control unit 24 and by the second control unit 26.

The controller 18b is coupled via a signal line 36 to the first gateway 28, which in turn is connected to the first control unit 24.

In addition, the first gateway 28 is connected in terms of signaling to the second control unit 26 via a signal line 38.

The controller 18b and thus the brake actuator unit 12b are therefore also connected in terms of signaling via separate signal lines 36, 38 both to the first control unit 24 and to the second control unit 26.

The brake actuator unit 12b can thus be actuated by the first control unit 24 and by the second control unit 26.

The same applies to the brake actuator units 12c and 12d on the rear axle.

The controller 18c is connected to the second gateway 30 via a signal line 40. The second gateway 30 is in turn coupled to the second control unit 26. In addition, the second gateway 30 is connected in terms of signaling to the first control unit 24 via a signal line 42.

As a result, the controller 18c and thus the brake actuator unit 12c are connected in terms of signaling via separate signal lines 40, 42 both to the first control unit 24 and to the second control unit 26.

For this reason, the brake actuator unit 12c can be actuated by the first control unit 24 and by the second control unit 26.

Furthermore, the controller 18d is connected to the second gateway 30 via a signal line 44. As already explained, the second gateway 30 is connected to the second control unit 26.

In addition, the second gateway 30 is connected to the first control unit 24 via a signal line 46.

Thus, the controller 18d and thus the brake actuator unit 12d are also connected in terms of signaling via separate signal lines 44, 46 both to the first control unit 24 and to the second control unit 26.

The brake actuator unit 12d can thus be actuated by the first control unit 24 and by the second control unit 26.

The braking system 10 further comprises a brake actuation unit 48.

The brake actuation unit 48 has a brake pedal 50 which can be actuated by a driver of the vehicle and which interacts with a simulator unit 52. The simulator unit 52 is used to generate a restoring force on the brake pedal 50.

In addition, a total of two pedal displacement sensors 54, 56 and a total of two pedal force sensors 58, 60 are provided within the brake actuation unit 48.

The pedal displacement sensors 54, 56 are designed to each detect an actuation displacement of the brake pedal 50.

The pedal force sensors 58, 60 permit an actuation force on the brake pedal 50 to be detected in each case.

The brake actuation unit 48 is connected in terms of signaling to the first control unit 24 via a signal line 62 and to the second control unit 26 via a signal line 64.

A signal generated by the brake actuation unit 48, which represents a drivers request, can therefore be taken into account in both the first control unit 24 and the second control unit 26.

The braking system 10 also comprises a parking brake switch 66 which is coupled to the first control unit 24 via a signal line 68 and to the second control unit 26 via a signal line 70.

The first control unit 24 can also be coupled to further control devices of the vehicle via a signal line 72. In particular, sensor values relating to the driving state are communicated to the first control unit 24 via the signal line 72. These relate e.g., to characteristic values of the driving dynamics such as a yaw rate.

In the same way, the second control unit 26 can be coupled to further control devices of the vehicle via a signal line 74. In particular, sensor values relating to the driving state are communicated to the second control unit 26 via the signal line 74, and these values can be the same as those already mentioned in connection with the first control unit 24.

Two mutually independent power supply units are provided for supplying power to the braking system 10.

A supply of power by a first power supply unit 76 is symbolized by dash-dotted arrows.

A supply of power by a second power supply unit 78 is symbolized by means of dashed arrows.

In the exemplary arrangement according to FIG. 1, a first power supply switch 80 and a second power supply switch 82 are also provided.

Both power supply switches 80, 82 are connected on the input side to both the first power supply unit 76 and to the second power supply unit 78.

On the output side, the first control unit 24, the first gateway 28, the brake actuator unit 12a and the brake actuator unit 12b are connected to the first power supply switch 80.

The first power supply switch 80 connects the first control unit 24, the first gateway 28 and the brake actuator units 12a, 12b to the first power supply unit 76 in a first switching position and to the second power supply unit 78 in a second switching position.

The second control unit 26, the second gateway 30, the brake actuator unit 12c and the brake actuator unit 12d are connected on the output side to the second power supply switch 82.

The second power supply switch 82 connects the second control unit 26, the second gateway 30 and the brake actuator units 12c, 12d to the first power supply unit 76 in a first switching position and to the second power supply unit 78 in a second switching position.

The brake actuation unit 48 is coupled both to the first power supply unit 76 and to the second power supply unit 78.

In the exemplary arrangement shown, the first control unit 24 is not only designed to actuate the brake actuator units 12a, 12b, 12c, 12d, but is also coupled to a steering actuator unit 86 via a signal line 84.

The second control unit 26 is also coupled to the steering actuator unit 86 via a signal line 88.

The steering actuator unit 86 can thus be actuated by the first control unit 24 and/or by the second control unit 26.

In the exemplary arrangement shown, the steering actuator unit 86 is a steering drive unit that can be associated with a front axle.

Alternatively, the steering actuator unit 86 is a feedback unit that can be associated with a steering wheel.

The first control unit 24 is also coupled via a signal line 90 to a steering actuation unit 92, which comprises a steering wheel 93.

The steering actuation unit 92 is likewise coupled to the second control unit 26 via a signal line 94.

The steering actuator unit 86 and the steering actuation unit 92 are both redundantly connected to the two power supply units 76, 78.

The braking system 10 shown in FIG. 1 is therefore a combined steering and braking system. It can also be referred to as a steering system, provided the appropriate components are available.

In normal operation, i.e. in an operating situation in which there is no defect or malfunction, the brake actuator units 12a, 12b, 12c, 12d and the steering actuator unit 86 are actuated by the first control unit 24 and/or the second control unit 26.

Signals generated by the brake actuation unit 48 and/or by the steering actuation unit 92, in particular driver requests relating to steering and braking, can be taken into account if this is necessary for the current driving operation of the associated vehicle.

At the same time, the control units 24, 26 can receive characteristic values and parameters from other controllers of the vehicle as well as sensor values detected by driving state sensors via the signal lines 72, 74 and take these into account when operating the brake actuator units 12a, 12b, 12c, 12d as well as the steering actuator unit 86.

Various failure scenarios are conceivable on the basis of this normal operation.

For example, one of the control units 24, 26 can fail.

In this case, however, all the brake actuator units 12a, 12b, 12c, 12d and the steering actuator unit 86 can be actuated by the other control unit 24, 26 in question. The braking system 10 is therefore still fully functional. This applies to both the braking function and the steering function.

Even if one of the power supply units 76, 78 fails, the braking system 10 continues to be fully functional, since it is then supplied with power by the other power supply unit 76, 78 in question. The same applies to the steering actuator unit 86.

If one of the brake actuator units 12a, 12b, 12c, 12d fails, these are obviously no longer available for producing a braking effect. In such a case, the braking system 10 works with the remaining three functional brake actuator units 12a, 12b, 12c, 12d and in this way can provide a braking power of approximately 70% compared to normal operation.

The same applies if one of the signal lines 32, 34, 36, 38, 40, 42, 44, 46 fails.

If the steering actuator unit 86 or one of the associated signal lines 84, 88 fails, the vehicle can be steered by selective braking interventions by the brake actuator units 12a, 12b, 12c, 12d. A steering function can therefore also be provided in this case.

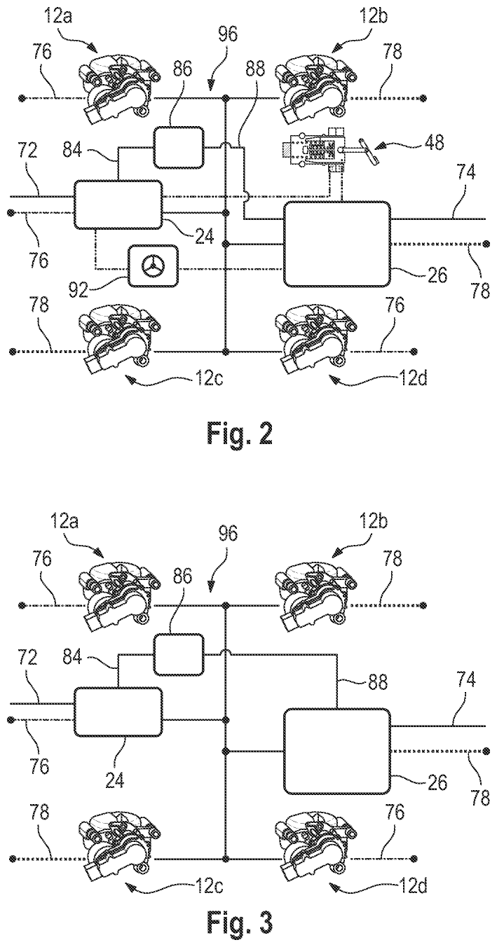

FIG. 2 shows a variant of the braking system 10. In the following, only the differences from the arrangement in FIG. 1 will be discussed.

The signal lines 32, 34, 36, 38, 40, 42, 44, 46 are now combined to form a bus system, which is designated by 96 as a whole.

In addition, the power supply switches 80, 82 are no longer present.

In this context, the first control unit 24 is only coupled to the first power supply unit 76 and the second control unit 26 is only coupled to the second power supply unit 78.

The brake actuator units 12a, 12b, 12c, 12d are now subdivided into two subsets, with a first subset comprising the brake actuator units 12a and 12d being coupled only to the first power supply unit 76.

A second subset, which comprises the brake actuator units 12b and 12c; is only coupled to the second power supply unit 78.

Thus, if one of the energy supply units 76, 78 fails, only two of the brake actuator units 12a, 12b, 12c, 12d and one of the control units 24, 26 are available.

Otherwise, reference can be made to the explanations for the variant from FIG. 1.

Both the variant from FIG. 1 and the variant from FIG. 2 comprise a brake actuation unit 48 and a steering actuation unit 92; however, this is optional.

If neither a brake actuation unit 48 nor a steering actuation unit 92 is provided, the braking system 10 can be used exclusively in combination with an autonomous or partially autonomous driving mode of an associated vehicle.

A variant of the braking system 10 from FIG. 2 which does not require a brake actuation unit 48 or a steering actuation unit 92 is shown in FIG. 3.

All the exemplary arrangements have been described above as braking systems 10 which are designed as combined braking and steering systems. However, the components relating to the steering system, in particular the steering actuator unit 86 and the steering actuation unit 92, are to be regarded as optional. The braking system 10 can therefore also be designed as a pure braking system.

1. A Braking system for a vehicle having at least four brakable wheels, comprising
at least four brake actuator units, each of which can be associated with one of the wheels of the vehicle,
a first electronic control unit, and
a second electronic control unit,
wherein each brake actuator unit has its own signal line via which a corresponding brake actuator units from the at least four brake actuator units is connected in terms of signaling to the first control unit and the second control unit, so that each of the brake actuator units can be actuated both by the operation of the first control unit and the second control unit.

2. The braking system according to claim 1, further comprising a first power supply unit and a second power supply unit, the power supply units being independent of one another.

3. The braking system according to claim 2, wherein a first subset of the brake actuator units is coupled to the first power supply unit for the supply of power and a second subset of the brake actuator units is coupled to the second power supply unit for the supply of power.

4. The braking system according to claim 2, wherein each of the brake actuator units can optionally be coupled to the first power supply unit and to the second power supply unit for the supply of power.

5. The braking system according to claim 2, wherein the first control unit and/or the second control unit can optionally be coupled to the first power supply unit and to the second power supply unit for the supply of power.

6. The braking system according to claim 2, wherein:
the first control unit is coupled to a first power supply switch for the supply of power, the first power supply switch connecting the first control unit to the first power supply unit in a first switching position and connecting the first control unit to the second power supply unit in a second switching position and/or
the second control unit is coupled to a second power supply switch for the supply of power, the second power supply switch connecting the second control unit to the first power supply unit in a first switching position and connecting the second control unit to the second power supply unit in a second switching position and
each of the brake actuator units is coupled to a first power supply switch or a second power supply switch for the supply of power, the first power switch connecting the relevant brake actuator unit to the first power supply unit in a first switching position and connecting the relevant brake actuator unit to the second power supply unit in a second switching position, and the second power supply switch connecting the relevant brake actuator unit to the first power supply unit in a first switching position and connecting the relevant brake actuator unit to the second power supply unit in a second switching position.

7. The braking system according to claim 1, wherein each of the brake actuator units comprises an electromechanical brake actuator.

8. The braking system according to claim 2, wherein a brake actuation unit is provided which is coupled in terms of signaling to both the first control unit and the second control unit, with the brake actuation unit comprising a brake pedal.

9. The braking system according to claim 1, wherein the first control unit and the second control unit are coupled to the signal lines of the brake actuator units via at least one gateway.

10. The braking system according to claim 1, wherein the first control unit and the second control unit are arranged adjacent to or at a distance from one another.

11. The braking system according to any of the claim 1, wherein at least one of the signal lines is a bus line.

12. The braking system according to claim 1, wherein the first control unit and/or the second control unit can be or is coupled in terms of signaling to a steering actuator unit, so that the steering actuator unit can be actuated by the first control unit and/or by the second control unit.

13. The braking system according to claim 12, wherein the steering actuator unit is a steering drive unit that can be associated with a front axle.

14. The braking system according to claim 12 wherein a steering actuation unit is coupled in terms of signaling both to the first control unit and the second control unit.

15. The braking system according to claim 1, wherein at least one driving state sensor is coupled in terms of signaling both to the first control unit and to the second control unit.

16. The braking system of claim 3, wherein the first subset and the second subset are free of intersections.

17. The braking system of claim 2, wherein:
the first control unit is coupled to a first power supply switch for the supply of power, the first power supply switch connecting the first control unit to the first power supply unit in a first switching position and connecting the first control unit to the second power supply unit in a second switching position and
the second control unit is coupled to a second power supply switch for the supply of power, the second power supply switch connecting the second control unit to the first power supply unit in a first switching position and connecting the second control unit to the second power supply unit in a second switching position or
each of the brake actuator units is coupled to a first power supply switch or a second power supply switch for the supply of power, the first power switch connecting the relevant brake actuator unit to the first power supply unit in a first switching position and connecting the relevant brake actuator unit to the second power supply unit in a second switching position, and the second power supply switch connecting the relevant brake actuator unit to the first power supply unit in a first switching position and connecting the relevant brake actuator unit to the second power supply unit in a second switching position.

18. The braking system of claim 12, wherein the steering actuator unit is a steering drive unit that can be associated with a feedback unit that can be associated with a steering wheel.

19. The braking system according to claim 18 wherein a steering actuation unit is coupled in terms of signaling both to the first control unit and the second control unit, wherein the steering actuation unit comprises a steering wheel.

20. The braking system according to claim 12, wherein at least one driving state sensor is coupled in terms of signaling both to the first control unit and to the second control unit.
